(19) United States
(12) Patent Application Publication
(10) Pub. No.: US 2021/0117949 A1
(43) Pub. Date: Apr. 22, 2021

(54) IRREGULAR SCAN DETECTION FOR RETAIL SYSTEMS

(71) Applicant: Shenzhen Malong Technologies Co., Ltd., Shenzhen (CN)

(72) Inventors: Sheng GUO, Shenzhen (CN); Haozhi ZHANG, Shenzhen (CN); Xun WANG, Shenzhen (CN); Weilin HUANG, Shenzhen (CN); Matthew Robert SCOTT, Shenzhen (CN)

(21) Appl. No.: 16/704,074

(22) Filed: Dec. 5, 2019

Related U.S. Application Data
(63) Continuation of application No. PCT/CN2019/111643, filed on Oct. 17, 2019.

(51) Int. Cl. G06Q 20/20; G06T 7/246; G06T 7/194; G06T 7/70

(52) U.S. Cl. CPC G06Q 20/208; G06T 7/248; G06T 2207/20084; G06T 7/70; G06T 7/194

(57) ABSTRACT

Aspects of this disclosure include technologies for detecting irregular scans, specifically when a retail system fails to collect the genuine information of a product. The disclosed retail system retrieves images covering a specific region, e.g., the designated scanning area. Further the disclosed retail system uses neural networks to detect the product from such images and track a moving path of the product over the specific region. Irregular scans may be detected when the tracked product in the images does not match what is collected by the scanner of the retail system.

### CROSS-REFERENCE TO RELATED APPLICATION

This application is a continuation of International Application No. PCT/CN2019/111643, filed Oct. 17, 2019.

### BACKGROUND

Barcode and radio-frequency identification (RFID) are two popular technologies used in the retail industry for reading and collecting data in general, and being commonly applied at the point of sale (POS) or otherwise used for asset tracking and inventory tracking in business. Barcodes were initially developed in linear or one-dimensional (1D) forms. Later, two-dimensional (2D) variants emerged, such as quick response code (QR code), for fast readability and greater storage capacity. Barcodes are scanned traditionally by special optical scanners called barcode readers, and such scanning generally requires line of sight visibility. RFID, however, uses radio waves to transmit information from RFID tags to an RFID reader. Typically, RFID tags contain unique identifiers; thus an RFID reader can simultaneously scan multiple RFID tags without line of sight visibility.

Irregular scans, such as missed scans or incorrect scans, have caused significant shrinkage and other problems (e.g., erroneous inventory information) for retailers, which may further implicate the supply chain and business. Retail systems would not work correctly with irregular scans, whether intentional or unintentional. Though some watchful clerks or self-checkout customers may notice irregular scans, more often, irregular scans simply slip through the retail systems without being noticed. Presently, retailers lack effective technical solutions to recognize, correct, or prevent irregular scans, especially with increasingly popular self-checkout retail systems. Accordingly, such technical solutions are needed to recognize, correct, or prevent irregular scans. To be effective, such technical solutions also need to be performed in real time or near real time when irregular scans occur.

### SUMMARY

This Summary is provided to introduce selected concepts that are further described below in the Detailed Description. This Summary is not intended to identify key features or essential features of the claimed subject matter, nor is it intended to be used as an aid in determining the scope of the claimed subject matter.

One of the technical objectives of the disclosed retail system is to detect irregular scans in real time or near real time, which requires a technically efficient implementation. This disclosure includes technical solutions for detecting irregular scans, specifically when a retail system fails to collect the genuine information of the scanned product. Various neural networks are utilized in a unique way for making technical contributions in detecting irregular scans. To do so, the disclosed retail system will retrieve images covering a predetermined region, e.g., the designated scanning area. In some embodiments, the disclosed retail system uses neural networks to detect a product from such images and track a moving path of the product over the predetermined region. Subsequently, the disclosed retail system uses neural networks to detect irregular scans, such as detecting irregular scans when the product in the images does not match what has been collected by the retail system.

In various aspects, systems, methods, and computer-readable storage devices are provided to improve a retail system's functions in detecting irregular scans. To do that, one aspect of the disclosed technology is to improve a computing device's functions to efficiently track a moving path, including the entry and exit time, of an object moving over a predetermined region. Another aspect of the disclosed technology is to improve a computing device's functions to accurately and efficiently detect an object and compare neural features of objects. Yet another aspect of the disclosed technology is to improve a computing device's functions to automatically correct irregular scans or communicate the detected irregular scans in real time or near real time.

### BRIEF DESCRIPTION OF THE DRAWING

The technology described herein is illustrated by way of example and not limited in the accompanying figures in which like reference numerals indicate similar elements and in which:

FIG. 1 is a schematic representation illustrating some product scanning examples, in accordance with at least one aspect of the technology described herein;

FIG. 2 is a block diagram illustrating an exemplary retail system configured to detect irregular scans, in accordance with at least one aspect of the technology described herein;

FIG. 3 is a schematic representation illustrating some exemplary components in an exemplary retail system, in accordance with at least one aspect of the technology described herein;

FIG. 4 is a flow diagram illustrating an exemplary process of detecting irregular scans, in accordance with at least one aspect of the technology described herein;

FIG. 5 is a flow diagram illustrating another exemplary process of detecting irregular scans, in accordance with at least one aspect of the technology described herein; and

FIG. 6 is a block diagram of an exemplary computing environment suitable for use in implementing various aspects of the technology described herein.

### DETAILED DESCRIPTION

The various technologies described herein are set forth with sufficient specificity to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Further, the term “based on” generally denotes that the precedent matter and succedent matter form a technical relationship, or the succedent condition is used in performing the precedent action.

A barcode, a seemingly trivial piece of label, can encode optical, machine-readable data. The universal product code (UPC) is a barcode symbology and commonly used at the POS for sales. Barcodes, particularly UPC barcodes, have shaped the modern economy. Barcodes or other product identifiers (e.g., RFID), ubiquitously affixed to most commercial products in the modern economy, have made checkout and inventory tracking more efficient in all retail sectors. Not only have they been used universally in retail checkout systems, they have been used for many other automatic identification and data collection tasks.

An irregular scan refers to the failure of the retail system to collect the genuine or accurate product information of the product, including missed scans, duplicated scans, erroneous scans, etc. By way of example, the scanner may miss the barcode due to various reasons, such as obstructions of the line of sight, insufficient time for scanning, or even fraud. Missed scans may be caused unintentionally or intentionally. Duplicated scans may be caused by moving the product back and forth before the scanner. Erroneous scans may be caused by damaged barcodes or even fraudulent behaviors, such as covering or replacing the genuine barcode with a different barcode, typically for another cheaper product.

The integrity of the scanning process, i.e., the process of reading the information encoded in the barcodes or other product identifiers, is critical to normal business. Irregular scans could cause significant shrinkage and other problems for retailers. Conversely, consumers could also be harmed by incorrect transactions caused by irregular scans. Retailers may try to educate their clerks to be cautious in checking out, or adding more clerks to the self-checkout area for supervising and monitoring. However, irregular scans still happen regularly without being noticed because presently there are no effective technical solutions to recognize, correct, or prevent irregular scans, especially with increasingly popular self-checkout retail systems.

Missed scans are a typical form of irregular scans, which could happen with clerk-operated checkout systems or self-checkout systems. Specific to self-checkout systems, one type of fraudulent behavior is to simulate the normal scanning process but without scanning the product, e.g., by moving the product through the scanning area and blocking the barcode. Even if clerks are dispatched to monitor the self-checkout systems, such disguised scanning behavior may still cause significant shrinkage for retailers.

Duplicated scans, if not rectified, cause consumers to overpay, which can be frustrating for consumers. Furthermore, a request for correcting duplicated scans typically slows down the checkout process. By way of example, a customer may accidentally scan the same product several times at a self-checkout machine. However, in order to remove duplicate transactions, the customer may have to wait for the assistance of a store manager, who may have to investigate all transactions.

It is more troublesome for a store manager to investigate irregular scans when the identifier (e.g., barcode or RFID) of the product has been damaged or switched. When there are numerous items in one purchase order, it can be very time consuming to verify each transaction manually.

There are many types of irregular scans. The ideal timing to rectify an irregular scan is at its occurrence. In this disclosure, technical solutions are disclosed to detect, correct, prevent, or report irregular scans in real time or near real time when irregular scans occur. At a high level, the disclosed retail system includes different components and neural networks to detect a product, track the moving path of the product over a scanning area, and to verify the product against the information collected by the retail system during the passing of the product over the scanning area.

In various embodiments, a product detector is used to detect the product in an image, and a product tracker will use the location of the product as a start point of tracking. Then, the product tracker can repeatedly predict the movement of the detected object at the later selected images, thus to determine the general moving path of the product over the scanning area. The product detector and product tracker may run alternatively to reduce errors in detection or tracking. Multi-object trackers may be built based on multiple single-object trackers.

To detect irregular scans, the disclosed system verifies the tracked product in the image with the scanned product as represented by the identifier (e.g., a UPC barcode) collected by the scanner. To do that, the similarity of their respective neural features may be compared via a comparison model. If the tracked product does not match the presumed product as collected by the scanner, an irregular scan may have occurred, for example, when the similarity measure is below a predetermined threshold. Similarly, if no information is collected by the scanner when the product travels through the scanning area, an irregular scan may have occurred. In some embodiments, this verification process occurs right after the product left the scanning area, so that any irregular scans may be detected and reported in real time or near real time. For instance, the disclosed system can detect and report irregular scans within 500 milliseconds after initiating the verification process in a technically efficient real time implementation, or within one second in another more relaxed near real time implementation.

In some embodiments, a fast one-stage detector or a light-head two-stage detector may be used to detect the product. Further, an online tracker may be used to efficiently track the moving path of the product over the scanning area. Even further, a space reduction technique may be introduced to reduce the complexity and time of the verification process, which is also discussed as the comparison process below. Based on the inventive design of the disclosed system, as further discussed in detail below, the tasks of detecting irregular scans can be performed by the disclosed system in real time or near real time. In contrast to conventional systems, the disclosed system has significant technical advantages, including automatically detecting, correcting, or mitigating irregular scans in real time or near real time.

The disclosed technical solutions can be applied in both clerk-assisted checkout systems or self-checkout systems. From the retailers' perspective, the disclosed technical solutions can help them not only mitigate shrinkage and maintain the integrity of their inventories, but also expand the functions of their retails systems, such as enabling concurrent scanning and correcting duplicated scanning. From the consumers' perspective, the disclosed technical solutions can help them buy authentic products at the correct price.

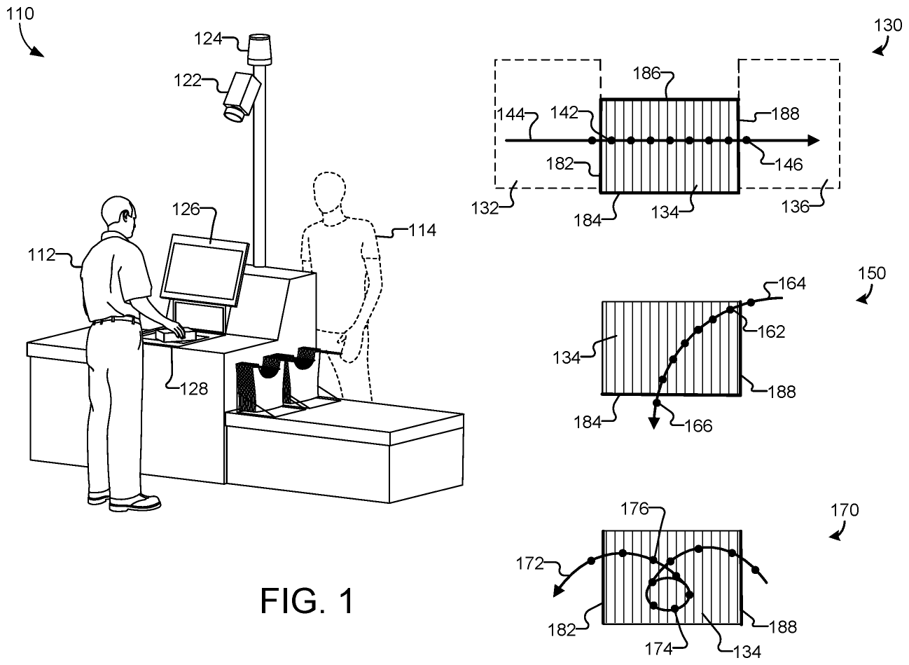

Having briefly described an overview of various aspects of the technology described herein, an exemplary operating environment in which aspects of the technology described herein may be implemented is described below. Referring to the figures in general and initially to FIG. 1 in particular, an exemplary operating environment for implementing the disclosed technical solutions is shown together with product scanning examples.

This operating environment is merely one example of a suitable computing environment and is not intended to suggest any limitation as to the scope of use or functionality of aspects of the technology described herein. Neither should this operating environment be interpreted as having any dependency or requirement relating to any one component nor any combination of components illustrated.

In this operating environment, checkout system 110 includes scanner 128, display 126, camera 122, and light 124. This checkout system may be used by clerk 112 to help customer 114 check out goods. Similarly, this checkout system may also be used by customer 114 for self-checkout.

Different from conventional checkout systems, checkout system 110 can track, based on images taken by camera 122, the moving path of a product when the product moves past a predetermined area above scanner 128, e.g., the scanning area. In various embodiments, the predetermined area is larger than the actual scanning area, so that a longer moving path of the product may be tracked. When the product leaves the scanning area, checkout system 110 can verify the product captured by camera 122 against the information collected by scanner 128, especially information collected during the time while the products are moving through the scanning area.

The range of products used for verification varies in different embodiments. The verification range may be set as large as the whole product space in the store. In this case, checkout system 110 can uniquely identify the product captured by camera 122, e.g., by comparing the neural features on the product against the whole product space; subsequently, it can detect any irregular scans by comparing the identity of the product against the information collected by scanner 128. To expedite the verification process, in some embodiments, checkout system 110 reduces the verification range to only information collected by scanner 128 in a specific session. A session may be limited to the transaction session with a particular customer. Even more narrowly, a session may be limited to the time when the product passes through the scanning area. In these embodiments, the ultimate identity of the product captured by camera 122 may not be required for the verification. Instead, the product captured by camera 122 can be directly compared against one or more candidates captured by scanner 128 in the session. An irregular scan can be detected if the product captured by camera 122 does not match with any verification candidates captured by scanner 128.

In some embodiments, checkout system 110 is to define the verification range based on two points in time, namely the time of the product entering the scanning area, and the time of the product exiting the scanning area. Generally, the entry time is when the moving path of the product intersects with the boundary of the scanning area for the first time. Conversely, the exit time is when the moving path of the product intersects with the boundary of the scanning area for the second time. Various examples in FIG. 1 show different scanning patterns. Camera 122 may take a continuous video or discrete images. Various points in the moving path, with their respective corresponding timestamps, are selected for implementing the disclosed technologies.

Example 130 shows three main areas, including loading area 132, scanning area 134, and packaging area 136. In various embodiments, the closest point to a boundary of the scanning area is deemed as an intersection point. Here, when moving path 144 of the product passes through scanning area 134, moving path 144 intersects with left boundary 182 at point 142 and with right boundary 188 at point 146. In this case, checkout system 110 may use the corresponding timestamp of point 142 as the entry time, and the corresponding timestamp of point 146 as the exit time. Accordingly, any information collected by scanner 128 between the entry time and the exit time may be used for verification against the product captured by camera 122 during the same time period. For example, scanner 128 may have captured a barcode belonging to a known product. Checkout system 110 can compare the known features of the known product to the features of the product in the images, as captured by camera 122. Substantial feature unmatch indicates a potential irregular scan.

Advantageously, checkout system 110 can handle diverse moving paths with different directions, different entry points, or different exit points. By way of example, different from example 130, in example 150, the product moves into the scanning area 134 by crossing right boundary 188 and exits from bottom boundary 184, thus forming moving path 164 with a different direction compared to moving path 144 in example 130. Regardless of the direction, checkout system 110 may use the corresponding timestamp of point 162 (i.e., the first intersection point) as the entry time, and the corresponding timestamp of point 166 (i.e., the second intersection point) as the exit time.

Similar to example 150, in example 170, the product enters into the scanning area 134 from right boundary 188. However, the product exits the scanning area from left boundary 182. Different from previous examples, the product has moved back and forth at the scanning area, which caused multiple scans at point 174 and point 176. Because moving path 172 only has one entry point and one exit point in relation to scanning area 134, checkout system 110 will be able to recognize any duplicated scans between the entry point and the exit point, and automatically remove any duplicated transactions accordingly.

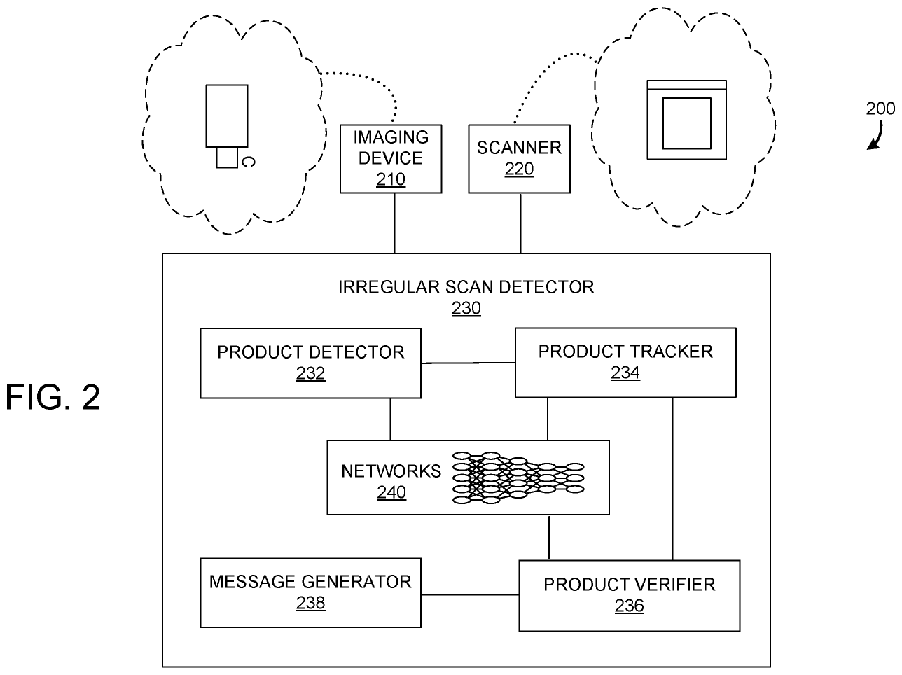

Turning now to FIG. 2, a block diagram is provided showing an operating environment in which some aspects of the present disclosure may be employed. It should be understood that this and other arrangements described herein are set forth only as examples. Other arrangements and elements (e.g., machines, interfaces, functions, orders, and grouping of functions, etc.) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by an entity may be carried out by hardware, firmware, and/or software. For instance, some functions may be carried out by a processor executing instructions stored in memory.

In various embodiments, irregular scan detector 230 is configured to receive imaging data from imaging device 210 and scanning data from scanner 220. Imaging device 210 may include digital still cameras, digital camcorders, thermographic cameras, depth cameras, etc., which are configured to send imaging data to irregular scan detector 230 via wired or wireless communication channels. Scanner 220 may include barcode scanners, QR code scanners, RFID scanners, etc., which are configured to send scanning data to irregular scan detector 230 via wired or wireless communication channels. In some embodiments, scanner 220 is configured to read UPC data of products. In various embodiments, imaging data generated by imaging device 210 includes images of a predetermined scanning area associated with scanner 220.

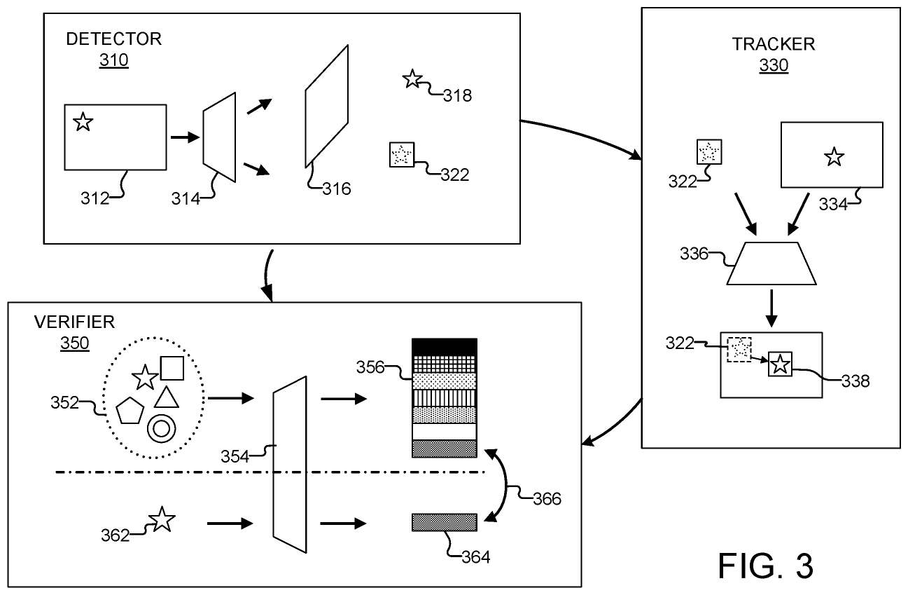

Among other components not shown, irregular scan detector 230 includes product detector 232, product tracker 234, product verifier 236, and message generator 238. Further, various components in irregular scan detector 230 may utilize networks 240 to achieve their respective functions. Networks 240 may include various specially designed and trained neural networks for detecting an object, tracking the object, and verifying the object. Various system components in irregular scan detector 230 are further discussed in connection with FIG. 3 below.

Product detector 232 includes an object detector that may use a convolutional neural network in networks 240 to detect an object in an image. In some embodiments, a one-stage model is used by product detector 232 for object detection. This leads to a simple and often fast enough model architecture for product detector 232 to detect a product in the image. In training the backbone network, which is usually pre-trained as an image classifier to extract product features from an image, only a single label is required to define the bounding box for each product. A large labeled dataset for various products may be used to learn good feature representations. In some embodiments, a two-stage model is used by product detector 232 for object detection. The two-stage model is to generate proposals at the first stage (a.k.a. the body) and to recognize or evaluate the proposals at the second stage (a.k.a. the head). Unlike conventional heavy-head designs (e.g., like Faster R-CNN, R-FCN, etc.), which are generally slower than one-stage models, product detector 232 uses a light-head design to achieve efficiency and accuracy simultaneously. Specifically, a light head may be achieved by using a large-kernel separable convolution to produce thin feature maps with small channel number. Further, a cheap R-CNN subnet, a pooling and single fully connected layer, may be used together with the thin feature map to achieve even a lighter head. Resultantly, product detector 232 can detect a product in the imaging data captured by imaging device 210 speedily and with high accuracy. Further, due to the convolutional nature of the detection process, product detector 232 can detect multiple products in parallel.

Product tracker 234 is configured to track the product between two images. As discussed previously, irregular scan detector 230 needs to detect irregular scans in real time or near real time. Accordingly, in some embodiments, product tracker 234 is designed as an online tracker, which does not use future images or frames for real-time predictions. However, in other embodiments, product tracker 234 may use offline tracking models to use both past and future images to make more accurate near real-time tracking predictions. Further, in some embodiments, product tracker 234 is designed as a single object tracker, which is to track only one object even if the images contain multiple objects. In other embodiments, product tracker 234 is designed as a multi-object tracker to track multiple objects presented in the images.

Architecturally, in some embodiments, product tracker 234 may contain at least four modules, including target initialization, appearance modeling, motion estimation, and target positioning. In some embodiments, product tracker 234 uses a CNN from networks 240 to track the product and generate the moving path of the product accordingly. Essentially, product tracker 234 is to distinguish the product from its background. To be faster, during the inference, the first few layers of the CNN may be used for neural feature extraction (e.g., for appearance modeling); then the last few layers may be used for predication (e.g., for target positioning). In one embodiment, the CNN used by product tracker 234 is based on Siamese region proposal network, which is end-to-end trained off-line with large-scale image pairs. The CNN includes Siamese subnetwork for feature extraction and region proposal subnetwork for proposing tracking regions. The region proposal subnetwork includes a classification branch and a regression branch. In the inference phase, the proposed framework is formulated as a local one-shot detection task. Product tracker 234 can pre-compute the template branch of the Siamese subnetwork and formulate the correlation layers as trivial convolution layers to perform online tracking.

Product verifier 236 is configured to verify the consistency between the product and its label, e.g., a barcode or an RFID. In some embodiments, product verifier 236 is to compare the features of the product with known features associated with the label. In some embodiments, product verifier 236 is to build a feature space for such comparison from potential candidate products. A simplified feature space is used in various embodiments to enable fast verification. To do that, only the product candidates related to the information collected by scanner 220 in a particular session may be used to construct the simplified feature space.

In some embodiments, product verifier 236 is to use a neural network from networks 240 to extract local features of the product. Further, segmentation techniques are used to segment the product from multiple images. Networks 240 may learn the local features of the product from respective segments of the multiple images that contain the product. In one embodiment, product verifier 236 is to determine the similarity between neural features of the product and neural features of a scanned product being scanned by scanner 220 between the entry time and the exit time of the product passing over the scanning area. If the similarity measurement is less than a predetermined threshold, an irregular scan may be reported. Resultantly, irregular scan detector 230 can detect irregular scans in real time or near real time when product verifier 236 quickly determines whether the product captured by imaging device 210 is found in the simplified feature space.

Message generator 238 is configured to generate an electronic message with information indicating an irregular scan. In some embodiments, message generator 238 includes the identity (e.g., a unique number or name of the device) or location (e.g., the absolute or relative location of the device) information of imaging device 210 or scanner 220 in the electronic message. In some embodiments, message generator 238 includes a text message in the electronic message. The text message may be displayed on a checkout machine associated with scanner 220. In some embodiments, the electronic message may be transmitted to a wireless device, such as a portable device used by a clerk in the store, so that the clerk may be summoned to the POS location to further resolve the problem.

In some embodiments, message generator 238 may store the imaging data captured by imaging device 210 during the scanning process (e.g., during the entry time and exit time of the product passing over scanner 220). Further, message generator 238 may include one or more images that are indicative of an irregular scan in the electronic message. Such indicative images usually show the product over the presumed scanning area. Message generator 238 may transmit such indicative images to remote devices, such as to the portal device of the clerk to enable the clerk to quickly comprehend the situation. Message generator 238 may also enable the clerk or the customer to review such indicative images locally, e.g., via the display of the checkout machine. In this way, involved parties can quickly identify the problematic transaction or product associated with the irregular scan, without more exhaustive searches as commonly required by conventional systems.

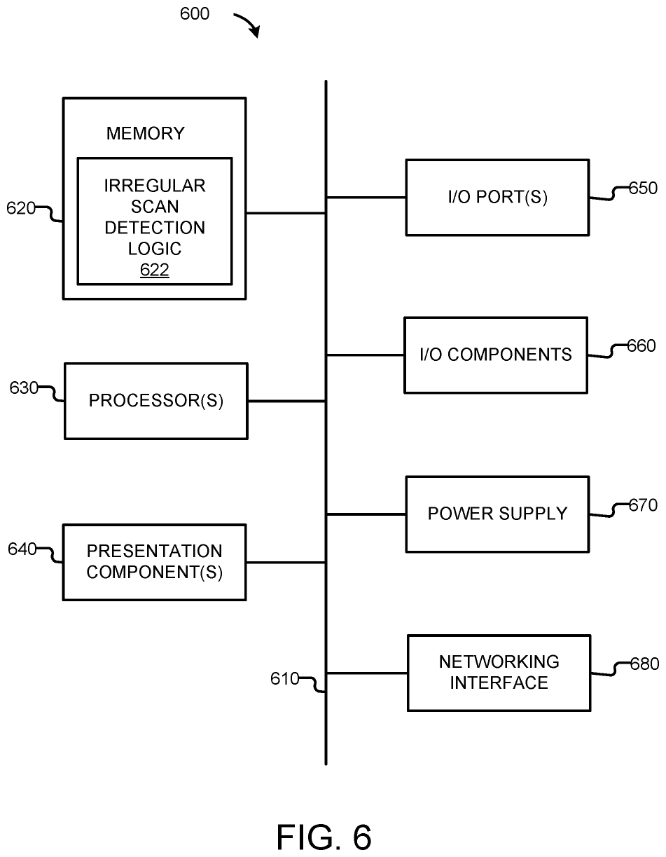

It should be understood that this irregular scan detector shown in FIG. 2 is an example. Each of the system components shown in FIG. 2 may be implemented on any type of computing devices, such as computing device 600 described in FIG. 6, for example. Further, various system components in this irregular scan detector may communicate with each other or other devices, such as imaging device 210, scanner 220, etc., via a network, which may include, without limitation, a local area network (LAN) or a wide area network (WAN). In exemplary implementations, WANs include the Internet or a cellular network, amongst any of a variety of possible public or private networks. Further, networks 240, as well as other components in this irregular scan detector, may be placed in a remote computing cloud or locally within a checkout machine.

Referring now to FIG. 3, a schematic representation is provided illustrating some exemplary components in an exemplary retail system, specifically, detector 310, tracker 330, and verifier 350, in accordance with at least one aspect of the technology described herein.

Using image 312 as the input, detector 310 is configured to use neural network 314 to separate the foreground from background 316, detect object 318 in the foreground, and determine location 322 of the object in the image, e.g., using as least one model as discussed in connection with FIG. 2. In various embodiments, neural network 314 output location 322 as a bounding box, usually represented by four values, such as the x and y coordinates of a corner of the bounding box as well as the height and width of the bounding box. Detector 310 may perform object detection tasks for dual-purposes, initially for target initialization in tracker 330, and subsequently for correcting the position of the tracked object. In some embodiments, tracker 330 uses detector 310 only for the target initialization. In other embodiments, tracker 330 also invokes detector 310 intermittently (e.g., every half second or every second) to correct the tracking trajectory.

Tracker 330 is configured to use neural network 336 to track the scanning processes in general, and particularly the moving path of the product in the scanning area. At a high level, tracker 330 is to locate the second location of the product in the second image based on the first location of the product in the first image, and construct the moving path of the product based on a displacement between the first location and the second location. In this example, tracker 330 takes location 322 and another image 334 as input, and use neural network 336 to determine the moving path of the product from location 322 to location 338, e.g., using as least one model as discussed in connection with FIG. 2.

In a regular scan, the product information should be collected by the scanner when the product moves through the scanning area. Conversely, in an irregular scan, the genuine product information is not retrieved by the scanner. Accordingly, verifier 350 is configured to determine whether the product captured in images matches the product as reported by the scanner.

Neural network 354 is trained to detect neural features of each known product, and such neural features may be stored and retrieved by verifier 350. In some embodiments, products 352 include all known products, and their neural features are stored in feature space 356. During the verification phrase, verifier 350 may generate neural features 364 from product 362 based on the same neural network, and try to recognize neural features 364 from feature space 356. In this way, the most similar known product may be identified by verifier 350, and compared to the product information collected by the scanner. It is a mismatch if neural features 364 could not be recognized in feature space 356, which in turn indicates an irregular scan.

In some embodiments, products 352 only contains the products as collected by the scanner during the transaction session. The transaction session may be limited to a particular customer, which includes all products purchased by the customer. The transaction session may be limited to the time period between the entry time and the exit time of the product passing through the scanning area. Usually, only one product is collected during such time period in a regular scan. If no information is collected by the scanner during such time period, verifier 350 will report an irregular scan. In either case, the absolute numbers of products in the transaction session is significantly reduced from the total number of products. Accordingly, verifier 350 can quickly determine whether product 362 matches a product in products 352. Again, a mismatch here indicates an irregular scan.

In some embodiments, instead of feeding products 352 through neural network 354 in real time, the existing neural features of products 352 may be retrieved from the training phrase. By comparing neural features 364 with the retrieved neural features of products 352, the complexity of the verification task is reduced during the inference phrase. In comparison to process 366, the similarity between two products may be measured based on Euclidean distance of their feature vectors or other feature comparison techniques. In response to the similarity being less than a threshold, an electronic message may be generated with information indicating an irregular scan.

Not only one image of the product, but all images containing the product in questions may be used by neural network 354 to generate neural features 364. In some embodiments, image segments containing the product in multiple images, e.g., the content in each bounding box generated by neural network 314 or neural network 336, are used by neural network 354 to generate neural features 364. In some embodiments, location and size information of bounding boxes generated by neural network 314 or neural network 336 are used as the input to neural network 354. In some embodiments, neural features of the product as recognized by neural network 314 or neural network 336 are used to augment neural features 364.

It is likely a regular scan if verifier 350 matches product 362 with an item in products 352 when products 352 are constructed based on the information collected by the scanner in the transaction session. If products 352 contains only one item, and product 362 does not match the only item in products 352, the identifier (e.g., the barcode) of the product is likely damaged or has been changed. As such, the disclosed system can also detect and report mistaken product identity based on such verification technique.

If the same product has been scanned multiple times, the duplicated items may be removed if they correspond to the same entry time and the same exit time as previously discussed. Specifically, in response to identifying a duplicated transaction of the product, the disclosed system is configured to automatically rectifying the duplicated transactions, such as by keeping only one transaction between the entry time and the exit time.

If multiple products are scanned at the similar time, products 352 may end up with multiple items. In this case, each product's moving path may still be tracked individually, and each product may be verified individually. Any irregular scans may still be detected and reported.

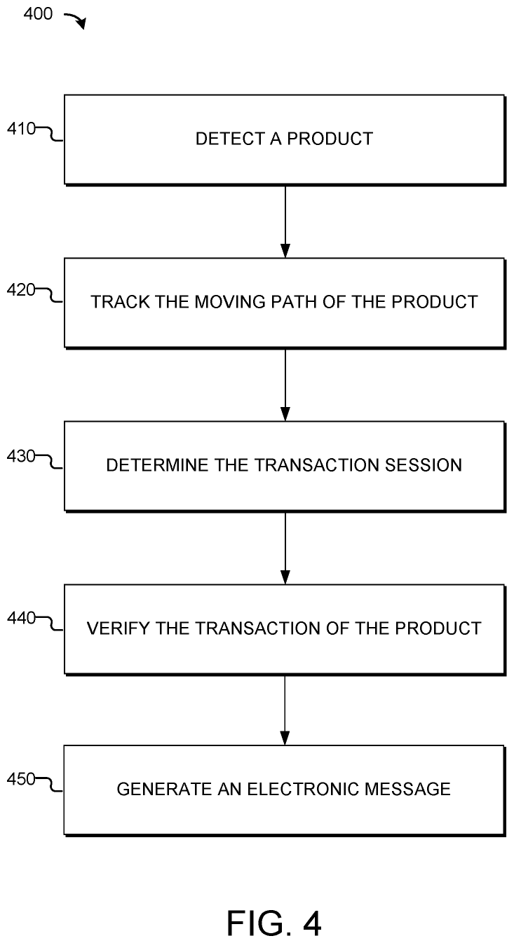

Referring now to FIG. 4, a flow diagram is provided that illustrates an exemplary process of detecting irregular scans. Each block of process 400, and other processes described herein, comprises a computing process that may be performed using any combination of hardware, firmware, or software. For instance, various functions may be carried out by a processor executing instructions stored in memory. The process may also be embodied as computer-usable instructions stored on computer storage media or devices. The process may be provided by an application, a service, or a combination thereof.

At block 410, the process is to detect a product, e.g., via product detector 232 in FIG. 2. In various embodiments, the product detector is to detect the product from an image covering a predetermined area connected to a scanner. To do so, product detector 232 may use a neural network to separate the foreground from the background of the image, detect an object in the foreground, and determine the location of the object in respect to the image. A bounding box may be used to represent the location of the object.

At block 420, the process is to track the moving path of the product, e.g., via product tracker 234 of FIG. 2. In various embodiments, the product tracker is to construct the moving path based on a displacement between respective locations of the product in two consecutive images or two sequential selected images. Further, the product tracker is to identify the entry point (also the entry time) and the exit point (also the exit time) of the moving path in relation to the scanning area, e.g., based on the first and second intersections of the moving path and the boundaries of the scanning area. In some embodiments, the product tracker concurrently tracks multiple objects and builds multiple moving paths accordingly.

At block 430, the process is to determine the transaction session, e.g., via product tracker 234 of FIG. 2. When the transaction session is based on per customer, transactions related to all information collected by the scanner for the customer may be used for the transaction session. When the transaction session is based on each scan activity, only transactions related to information collected by the scanner during the entry time and the exit time of the product's moving path may be used for the transaction session. In this case, the disclosed system will determine, based on the moving path, the first time of the product entering the scanning area, and a second time of the product exiting the scanning area. Therefore, the disclosed system can generate the transaction session based on scanning events between the first time and the second time.

At block 440, the process is to verify the transaction of the product, e.g., via product verifier 236 of FIG. 2. In some embodiments, the product verifier is to verify a transaction of the product from a transaction session associated with the scanner. In some embodiments, the product verifier is to generate neural features of the product from multiple images of the product, and to determine a similarity between neural features of the product and neural features of a scanned product being scanned between the first time and the second time, or otherwise contained in the selected transaction session. The transaction session usually contains the UPC of the scanned product. Accordingly, the product verifier may retrieve the neural features of the scanned product based on the UPC of the scanned product.

At block 450, the process is to generate an electronic message, e.g., via message generator 238 of FIG. 2. In some embodiments, the electronic message contains information indicating an irregular scan, and is generated in response to the similarity between the product captured by the camera and the product information collected by the scanner being less than a threshold. In some embodiments, in response to missing the transaction of the product from the transaction session, message generator 238 will generate an electronic message to indicate an irregular scan event, and cause the electronic message to be displayed in a wireless device, such as carried by a clerk.

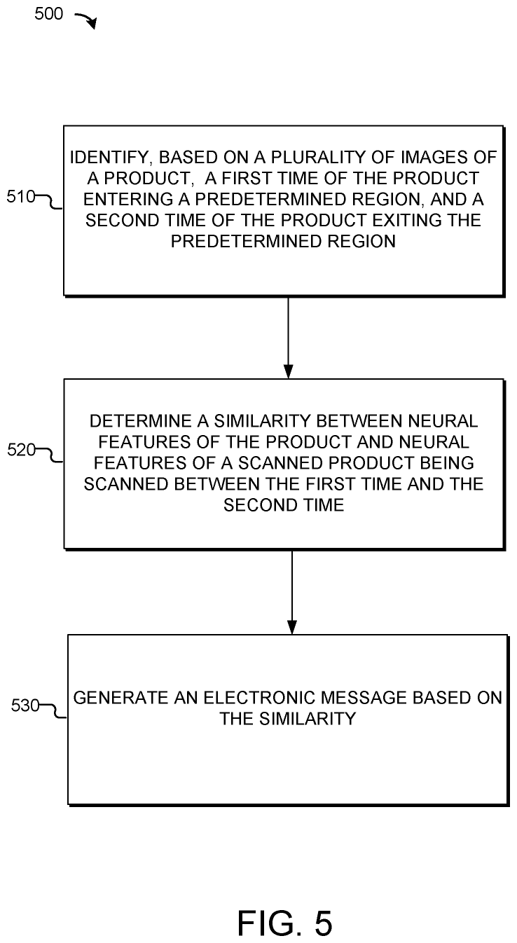

Turning now to FIG. 5, a flow diagram is provided to illustrate another exemplary process of detecting irregular scans. Each block of process 500, and other processes described herein, comprises a computing process that may be performed using any combination of hardware, firmware, or software. For instance, various functions may be carried out by a processor executing instructions stored in memory. The processes may also be embodied as computer-usable instructions stored on computer storage media or devices. The process may be provided by an application, a service, or a combination thereof.

At block 510, the process is to identify, based on a plurality of images of a product, a first time of the product entering a predetermined region, and a second time of the product exiting the predetermined region. To do that, the disclosed system tracks the moving path of the product, and identifies the intersection points between the moving path and the boundaries of the predetermined region. In various embodiments, a moving path has only one entry point and one exit point in relation to the predetermined region. The product is permitted to remain in the predetermined region for indefinite time. In various embodiments, the predetermined region is substantially similar to or at least covers the designated scanning area connected to the scanner.

At block 520, the process is to determine a similarity between neural features of the product and neural features of a scanned product being scanned between the first time and the second time. In some embodiments, the neural features of the product captured in the images can be generated by a neural network (e.g., neural network 354 in FIG. 3) from the images. In some embodiments, the neural features of the product as determined by neural network 314 and neural network 336 may also be used to facilitate the similarity measure, such as the output from neural network 314 or neural network 336 may serve as the input to neural network 354 in FIG. 3.

At block 530, the process is to generate an electronic message based on the similarity. For example, if the similarity is below a predetermined threshold, the electronic message may be generated to indicate an irregular scan.

Accordingly, we have described various aspects of the technology for detecting mislabeled products. It is understood that various features, sub-combinations, and modifications of the embodiments described herein are of utility and may be employed in other embodiments without reference to other features or sub-combinations. Moreover, the order and sequences of steps shown in the above example processes are not meant to limit the scope of the present disclosure in any way, and in fact, the steps may occur in a variety of different sequences within embodiments hereof. Such variations and combinations thereof are also contemplated to be within the scope of embodiments of this disclosure.

Referring to FIG. 6, an exemplary operating environment for implementing aspects of the technology described herein is shown and designated generally as computing device 600. Computing device 600 is but one example of a suitable computing environment and is not intended to suggest any limitation as to the scope of use of the technology described herein. Neither should the computing device 600 be interpreted as having any dependency or requirement relating to any one or combination of components illustrated.

The technology described herein may be described in the general context of computer code or machine-useable instructions, including computer-executable instructions such as program components, being executed by a computer or other machine. Generally, program components, including routines, programs, objects, components, data structures, and the like, refer to code that performs particular tasks or implements particular abstract data types. The technology described herein may be practiced in a variety of system configurations, including handheld devices, consumer electronics, general-purpose computers, and specialty computing devices, etc. Aspects of the technology described herein may also be practiced in distributed computing environments where tasks are performed by remote-processing devices that are connected through a communications network.

With continued reference to FIG. 6, computing device 600 includes a bus 610 that directly or indirectly couples the following devices: memory 620, processors 630, presentation components 640, input/output (I/O) ports 650, I/O components 660, and an illustrative power supply 670. Bus 610 may include an address bus, data bus, or a combination thereof. Although the various blocks of FIG. 6 are shown with lines for the sake of clarity, in reality, delineating various components is not so clear, and metaphorically, the lines would more accurately be grey and fuzzy. For example, one may consider a presentation component such as a display device to be an I/O component. The inventors hereof recognize that such is the nature of the art and reiterate that the diagram of FIG. 6 is merely illustrative of an exemplary computing device that can be used in connection with different aspects of the technology described herein. Distinction is not made between such categories as “workstation,” “server,” “laptop,” “handheld device,” etc., as all are contemplated within the scope of FIG. 6 and refers to “computer” or “computing device.”

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules, or other data in a modulated data signal such as a carrier wave or other transport mechanism and includes any information delivery media. The term “modulated data signal” means a signal that has its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 620 includes computer storage media in the form of volatile and/or nonvolatile memory. The memory 620 may be removable, non-removable, or a combination thereof. Exemplary memory includes solid-state memory, hard drives, optical-disc drives, etc. Computing device 600 includes processors 630 that read data from various entities such as bus 610, memory 620, or I/O components 660. Presentation component(s) 640 present data indications to a user or other device. Exemplary presentation components 640 include a display device, speaker, printing component, vibrating component, etc. I/O ports 650 allow computing device 600 to be logically coupled to other devices, including I/O components 660, some of which may be built in.

In various embodiments, memory 620 includes, in particular, temporal and persistent copies of irregular scan detection logic 622. Irregular scan detection logic 622 includes instructions that, when executed by processor 630, result in computing device 600 performing functions, such as, but not limited to, processes 400 and 500, as well as various processes connected to FIG. 3. In various embodiments, irregular scan detection logic 622 includes instruction that, when executed by processors 630, result in computing device 600 performing various functions associated with, but not limited to, product detector 232, product verifier 236, product tracker 234, irregular scan detector 230, message generator 238, in connection with FIG. 2; tracker 330, detector 310, and verifier 350, in connection with FIG. 3.

In some embodiments, processors 630 may be packed together with irregular scan detection logic 622. In some embodiments, processors 630 may be packaged together with irregular scan detection logic 622 to form a System in Package (SiP). In some embodiments, processors 630 cam be integrated on the same die with irregular scan detection logic 622. In some embodiments, processors 630 can be integrated on the same die with irregular scan detection logic 622 to form a System on Chip (SoC).

Illustrative I/O components include a microphone, joystick, game pad, satellite dish, scanner, printer, display device, wireless device, a controller (such as a stylus, a keyboard, and a mouse), a natural user interface (NUI), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 630 may be direct or via a coupling utilizing a serial port, parallel port, and/or other interface and/or system bus known in the art. Furthermore, the digitizer input component may be a component separate from an output component such as a display device. In some aspects, the usable input area of a digitizer may coexist with the display area of a display device, be integrated with the display device, or may exist as a separate device overlaying or otherwise appended to a display device. Any and all such variations, and any combination thereof, are contemplated to be within the scope of aspects of the technology described herein.

Computing device 600 may include networking interface 680. The networking interface 680 includes a network interface controller (NIC) that transmits and receives data. The networking interface 680 may use wired technologies (e.g., coaxial cable, twisted pair, optical fiber, etc.) or wireless technologies (e.g., terrestrial microwave, communications satellites, cellular, radio and spread spectrum technologies, etc.). Particularly, the networking interface 680 may include a wireless terminal adapted to receive communications and media over various wireless networks. Computing device 600 may communicate with other devices via the networking interface 680 using radio communication technologies. The radio communications may be a short-range connection, a long-range connection, or a combination of both a short-range and a long-range wireless telecommunications connection. A short-range connection may include a Wi-Fi® connection to a device (e.g., mobile hotspot) that provides access to a wireless communications network, such as a wireless local area network (WLAN) connection using the 802.11 protocol. A Bluetooth connection to another computing device is a second example of a short-range connection. A long-range connection may include a connection using various wireless networks, including 1G, 2G, 3G, 4G, 5G, etc., or based on various standards or protocols, including General Packet Radio Service (GPRS), Enhanced Data rates for GSM Evolution (EDGE), Global System for Mobiles (GSM), Code Division Multiple Access (CDMA), Time Division Multiple Access (TDMA), Long-Term Evolution (LTE), 802.16 standards, etc.

The technology described herein has been described in relation to particular aspects, which are intended in all respects to be illustrative rather than restrictive. While the technology described herein is susceptible to various modifications and alternative constructions, certain illustrated aspects thereof are shown in the drawings and have been described above in detail. It should be understood, however, that there is no intention to limit the technology described herein to the specific forms disclosed, but on the contrary, the intention is to cover all modifications, alternative constructions, and equivalents falling within the spirit and scope of the technology described herein.

What is claimed is:

1. A computer-implemented method for detecting irregular scans, comprising:
identifying, based on a plurality of images of a product, an entry time of the product entering a predetermined region, and an exit time of the product exiting the predetermined region;
determining a similarity between neural features of the product and neural features of a scanned product being scanned between the entry time and the exit time; and
generating an electronic message based on the similarity.

2. The method of claim 1, wherein identifying the second time comprises:
tracking, based on the plurality of images of the product, a moving path of the product over the predetermined region; and
identifying the exit time based on a later intersection of the moving path and a boundary of the predetermined region.

3. The method of claim 1, further comprising:
separating, via a neural network, a foreground of an image of the plurality of images from a background of the image;
detecting an object in the foreground of the image; and
determining the location of the object in the image.

4. The method of claim 3, wherein the neural network is a first neural network, the image is a first image, and the location is a first location; wherein tracking the moving path comprises:
locating, via a second neural network, a second location of the product in a second image based on the first location; and
constructing the moving path based on a displacement between the first location and the second location.

5. The method of claim 1, further comprising:
generating, via a neural network, the neural features of the product based on respective portions of the plurality of images that contain the product; and
retrieving the neural features of the scanned product from a data storage.

6. The method of claim 1, wherein generating the electronic message further comprises:
in response to the similarity being less than a threshold, generating the electronic message with information indicating an irregular scan.

7. The method of claim 1, further comprising:
causing the electronic message to be displayed on a checkout machine associated with the predetermined region; and
causing a wireless device to receive an identity or location of the checkout machine.

8. A retail system configured to detect irregular scans, comprising:
a processor; and
a memory have instructions stored thereon, wherein the instructions, when executed by the processor, cause the processor to perform operations, comprising:
detecting an object from a first image of a plurality of images covering a predetermined region connected to a scanner;
tracking a moving path of the object over the predetermined region;
verifying a transaction of the product from a transaction session associated with the scanner, the transaction session being generated based on the moving path of the object over the predetermined region.

9. The retail system of claim 8, wherein the operations further comprising:
determining, based on the moving path, a first time of the product entering the predetermined region, and a second time of the product exiting the predetermined region; and
generating the transaction session based on scanning events between the first time and the second time.

10. The retail system of claim 8, wherein the operation of verifying the transaction of the product comprises:
generating neural features of the product from the plurality of images;
determining a similarity between neural features of the product and neural features of a scanned product being scanned between the first time and the second time; and
in response to the similarity being less than a threshold, generating an electronic message with information indicating an irregular scan.

11. The retail system of claim 10, wherein the operation of verifying the transaction of the product further comprises:
retrieving the neural features of the scanned product based on a universal product code of the scanned product.

12. The retail system of claim 8, wherein the operations further comprising:
in response to the transaction of the product being missing from the transaction session, generating the electronic message to indicate an irregular scan; and
causing the electronic message to be displayed in a wireless device.

13. The retail system of claim 8, wherein the operations further comprising:
in response to identifying a duplicated transaction of the product, automatically rectifying the duplicated transaction.

14. The retail system of claim 8, wherein tracking the moving path of the object comprises:
separating the moving path of the object from another moving path of another object that moves together with the object.

15. The retail system of claim 8, further comprising:
the scanner configured to scan a universal product code of the product; and
an imaging device, operatively connected to the scanner, configured to generate the plurality of images.

16. A computer-readable storage device encoded with instructions that, when executed, cause one or more processors of a computing system to perform operations, comprising:
identifying, based on a plurality of images of a product, an entry time of the product entering a predetermined region, and an exit time of the product exiting the predetermined region;
determining a similarity between the product and a scanned product being scanned between the entry time and the exit time; and
generating an electronic message based on the similarity.

17. The computer-readable storage device of claim 16, wherein identifying the second time comprises:
tracking, based on the plurality of images of the product, a moving path of the product over the predetermined region; and
identifying the exit time based on a later intersection of the moving path and a boundary of the predetermined region.

18. The computer-readable storage device of claim 17, wherein tracking the moving path comprises:
constructing the moving path based on a displacement between respective locations of the product in two consecutive images of the plurality of images.

19. The computer-readable storage device of claim 16, wherein the operations further comprising:
detecting, via a neural network, the product in the foreground of an image of the plurality of images; and
determining, via the neural network, the location of the product in the image.

20. The computer-readable storage device of claim 16, wherein generating the electronic message further comprises:
in response to the similarity being less than a threshold, generating the electronic message with information indicating an irregular scan.
